(19) United States
(12) Patent Application Publication
(10) Pub. No.: US 2007/0115085 A1
(43) Pub. Date: May 24, 2007

(54) Direct current link inductor for power source filtration

(75) Inventor: James H. Clemmons, Freeport, IL (US)

Correspondence Address: Hamilton Sundstrand Corporation, 4747 Harrison Avenue, PO Box 7002, Rockford, IL, 61125-7002, US

(73) Assignee: Hamilton Sundstrand Corporation

(21) Appl. No.: 11/283,109

(22) Filed: Nov. 18, 2005

(51) Int. Cl. H01F 27/34

(52) U.S. Cl. 336/181

(57) ABSTRACT

An inductor with a primary winding on a magnetic core that produces a primary magnetic field H1 with a current I₁ has an electromagnetic field source that generates a secondary magnetic field H₂ in the core that opposes the primary magnetic field H₁ to produce a low net magnetic field H_{NET} in the core to prevent magnetic saturation of the core.

### FIELD OF THE INVENTION

The invention relates to electrical power sources for supplying and filtering direct current (DC) power, and more particularly to such power sources that have inductive filter elements.

### BACKGROUND OF THE INVENTION

Electrical power sources that supply and filter DC to a load, such as sources that convert alternating current (AC) current to DC current for a load, generally comprise a rectifier circuit for converting the AC current to pulsating DC current and a filter circuit for converting the pulsating DC to steady-state DC. The rectifier circuit connects to the filter circuit by way of a DC link that generally comprises an inductor that serves as part of the filter circuit to form a choke-input filter circuit. Of course, the total current, including ripple current through the filter circuit and steady-state current through a load applied to the output of the filter circuit passes through the inductor. The total energy stored in the inductor is ½ LI², wherein L is the inductance of the inductor and I is the total current passing through the inductor. The inductor has to be large enough to store this total energy.

Other applications that use such a DC link inductor as part of a power source include electrical controls for loads, such as motor speed controls for brushless DC motors, that tend to generate unwanted harmonics. The DC link inductor filters out the unwanted harmonics in such applications.

When a high level of DC passes through an inductor, the magnetic core for the inductor generally must have an air gap to avoid magnetic saturation of the inductor. The air gap has the effect of increasing the length of the magnetic path through the magnetic core. The resulting increase in magnetic path length causes the magnetic field “H” in the inductor to decrease. The reduced H field puts the magnetic operating point of the inductor in a linear region of the inductor's hysteresis loop where the permeability of its magnetic core is relatively large. Even though the core permeability is large, the air gap causes the effective permeability to be less than the magnetic core permeability. Since the inductance of the inductor is proportional to the effective permeability and inversely proportional to the magnetic length of the inductor, the introduction of an air gap into the magnetic core of the inductor reduces its inductance.

Since the air gap is required to prevent magnetic saturation of the inductor, to achieve the same inductance as before the introduction of the air gap, the inductor must have an increased number of winding turns or an increased magnetic core area. It is generally preferable to increase the magnetic core area since the addition of turns also increases the inductor's H field, which may require an increase in the air gap to prevent saturation due to the increased H field. In short, high-level DC passing through an inductor requires that the inductor be larger, heavier and more costly than if there were no DC passing through it.

An alternative to using an air gap to prevent magnetic saturation of the inductor involves placing a permanent magnet within the magnetic core to serve as a secondary magnetic field source that opposes the magnetic field generated by current that passes through the inductor's winding. Although this alternative approach is simple and requires no extra components, it has several disadvantages.

First, there is no convenient way to control the magnetic field generated by the permanent magnet. Thus, the opposing magnetic field that the permanent magnet generates cannot change in response to varying inductor current. In fact, the magnetic field of the permanent magnet may dominate when the level of inductor current is low. Another disadvantage is that materials that have sufficient magnetic retentivity to be suitable for use as the permanent magnet have low permeability and therefore introduce an equivalent air gap when placed within the magnetic core of the inductor.

### SUMMARY OF THE INVENTION

The present invention inserts an electromagnetic H field into the inductor that opposes the H field generated by the DC that passes through its primary winding. The net H field is thus reduced and the magnetic operating point is then within a linear region of the inductor's hysteresis loop without the introduction of a large air gap. In one possible embodiment, the inductor has an auxiliary winding and a current passes through the auxiliary winding that creates an opposing H field. A feedback circuit may control the amount of current passing through the auxiliary winding to adjust the opposing H field to keep the magnetic operating point of the inductor in a linear region of the inductor's hysteresis loop regardless of DC current that passes through its primary winding.

Generally, the invention comprises an inductor with a primary winding on a magnetic core that produces a primary magnetic field H₁ with a current I₁, comprising: an electromagnetic field source that generates a secondary magnetic field H₂ in the core that opposes the primary magnetic field H₁ to produce a low net magnetic field H_{NET} in the core to prevent magnetic saturation of the core.

### DESCRIPTION OF THE DRAWINGS

FIG. 1 is a perspective view of a typical inductor with an air gap in its magnetic core according to the prior art.

FIG. 2 is a perspective view of an inductor that has a permanent magnet inserted in a gap of its magnetic core according to the prior art.

FIG. 3 is a perspective view of an inductor according to a possible embodiment of the invention that has an auxiliary winding wound around its magnetic core.

FIG. 4 is a simple schematic of one possible embodiment of a feedback circuit to control current through the auxiliary winding of the embodiment of the invention shown in FIG. 3.

### DETAILED DESCRIPTION OF THE INVENTION

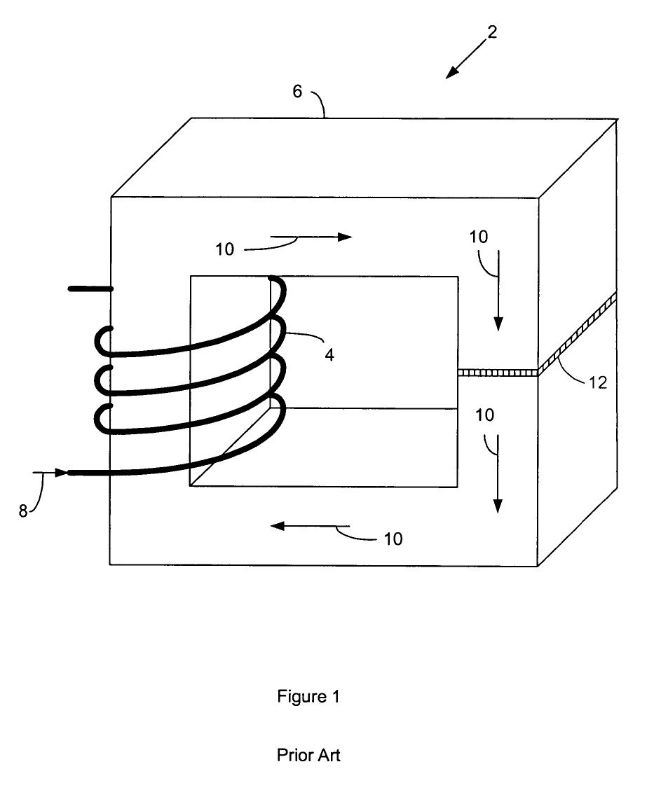

FIG. 1 is a perspective view of a typical inductor 2 according to the prior art. The inductor 2 has a primary winding 4 of N turns on a magnetic core 6. The primary winding 4 carries a current I along a direction indicated by arrow 8. The current I generates a magnetic field H along a magnetic path indicated by arrows 10. The magnetic core 6 has an air gap 12 that is placed across the magnetic path 10. For the typical inductor 2, the magnetic field H may be represented by:

$$H = \frac{KNI}{{I}_{e}}$$

wherein K is a constant and Iₑ is the effective length of the magnetic path 10. Of course, the air gap 12 increases the effective length of the magnetic path 10, and thereby it reduces the possibility of magnetic saturation by reducing H.

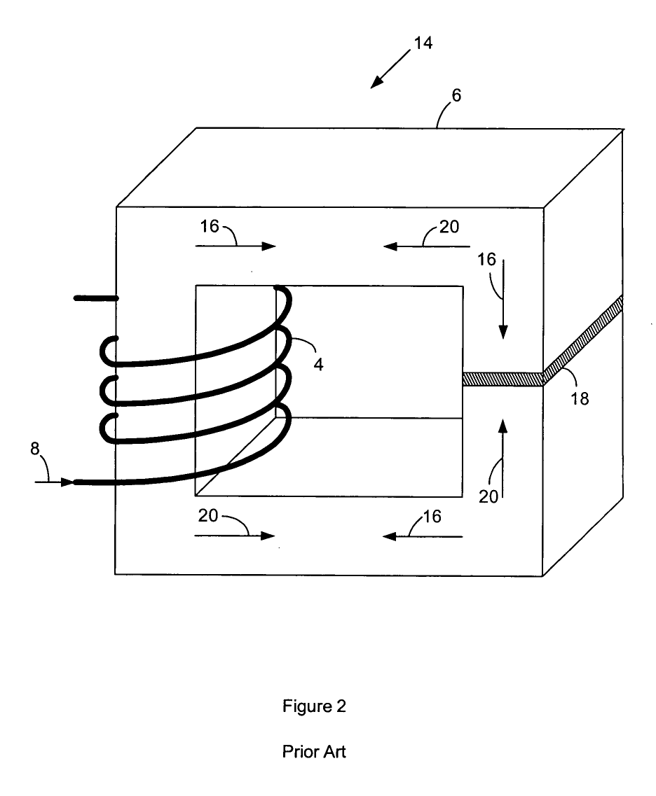

FIG. 2 is a perspective view of another inductor 14 according to the prior art. The inductor 14 has a primary winding 4 of N turns on a magnetic core 6. The primary winding 4 carries a current I₁ along a direction indicated by arrow 8. The current I₁ generates a primary magnetic field H₁ along a magnetic path that extends around the magnetic core 6 in a direction indicated by arrow 16. A permanent magnet 18 serves as a secondary magnetic field generator for generating a magnetic field H₂ that extends around the magnetic core 6 in a direction that opposes the primary magnetic field H₁ as indicated by arrow 20. The permanent magnet 18 may conveniently mount in place of the air gap 12 as shown in FIG. 1 to generate a secondary magnetic field H₂ within the magnetic core 6 in a direction that opposes the primary magnetic field H₁.

The magnetic field H₁ in this case may be represented by:

$${H}_{1} = \frac{{KNI}_{1}}{{I}_{e}}$$

In this case, the effective length of the magnetic path Iₑ may be less than with the inductor 2 shown in FIG. 1 because the actual air gap may be less than the air gap 12. Thus, the inductor 14 may have a higher value of primary magnetic field H₁ for the number of turns N for the primary winding 4 and same size of magnetic core 6.

Since the secondary magnetic field H₂ in the magnetic core 6 that the permanent magnet 18 generates opposes the primary magnetic field H₁, the net magnetic field H_{NET} may be represented by:
H_{NET}=H₁−H₂
Thus, the secondary magnetic field H₂ generated by the permanent magnet 18 may cancel out part of the primary magnetic field H₁ to prevent magnetic saturation of the magnetic core 6 for the inductor 14. Although the inductor 14 is simple and requires no extra components, it has several disadvantages.

First, there is no convenient way to control the secondary magnetic field H₂ that is generated by the permanent magnet 18, particularly when the permanent magnet 18 intersects the magnetic core 6 as shown in FIG. 2. Thus, the secondary magnetic field H₂ cannot change in response to varying current I₁ so that the net magnetic field H_{NET} is always minimised. In fact, the secondary magnetic field H₂ may dominate when the level of current I₁ is low. Another disadvantage is that materials that have sufficient magnetic retentivity to be suitable for use as the permanent magnet 18 have low permeability and therefore introduce an equivalent air gap when intersecting the magnetic core 6 as shown in FIG. 2.

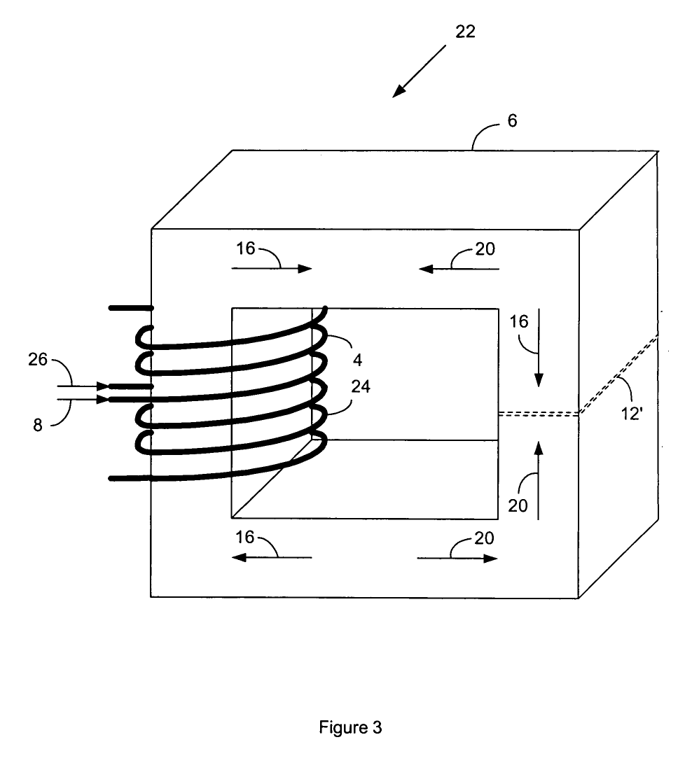

FIG. 3 is a perspective view of an inductor 22 according to a possible embodiment of the invention that obviates the disadvantages of the inductor 14 shown in FIG. 2. The inductor 22 has a primary winding 4 of N₁ turns on a magnetic core 6. The primary winding 4 carries a current I₁ along a direction indicated by arrow 8. The current I₁ generates a primary magnetic field H₁ along a magnetic path that extends around the magnetic core 6 in a direction indicated by arrow 16.

The magnetic field H₁ in this case may be represented by:

$${H}_{1} = \frac{{KN}_{1} {I}_{1}}{{I}_{e}}$$

The effective length of the magnetic path Iₑ may be less than with the inductor 2 shown in FIG. 1 because there may be no air gap 12. Thus, the inductor 22 may have a higher value of primary magnetic field H₁ for the number of turns N for the winding 4 and same size of magnetic core 6. In addition, the magnetic path Iₑ may also be less than with the inductor 14 when the permanent magnet 18 intersects the magnetic core 6 as shown in FIG. 2.

The inductor 22 has a secondary auxiliary winding 24 that carries a current I₂ along a direction indicated by arrow 20. The current I₂ in the secondary winding 24 lets it serve as an electromagnetic field source for generating a secondary magnetic field H₂ along the magnetic path that extends around the magnetic core 6 and opposes the primary magnetic field H₁ in a direction indicated by arrow 20.

The secondary magnetic field H₂ in this case may be represented by:

$${H}_{2} = \frac{{KN}_{2} {I}_{2}}{{I}_{e}}$$

Since the secondary magnetic field H₂ in the magnetic core 6 that the secondary winding 24 generates opposes the primary magnetic field H₁, the net magnetic field H_{NET} may be represented by:
H_{NET}=H₁−H₂

The intensity of the secondary magnetic field H₂ may track the intensity of the primary magnetic field H₁ by appropriately adjusting the level of current I₂ to produce a net magnetic field H_{NET} of 0 regardless of the level of current I₁. In this way, the magnetic core 6 of the inductor 22 cannot saturate regardless of the level of current I₁ yet the secondary magnetic field H₂ cannot dominate when the level of current I₁ is low. Furthermore, there is no permanent magnet 18 with its low permeability to adversely affect the effective length Iₑ of the magnetic path in the magnetic core 6. Optionally, a small air gap 12′, such as shown in dotted line, may be introduced for control purposes, but if so used it may be much smaller than the air gap 12 used for the inductor 2 shown in FIG. 1.

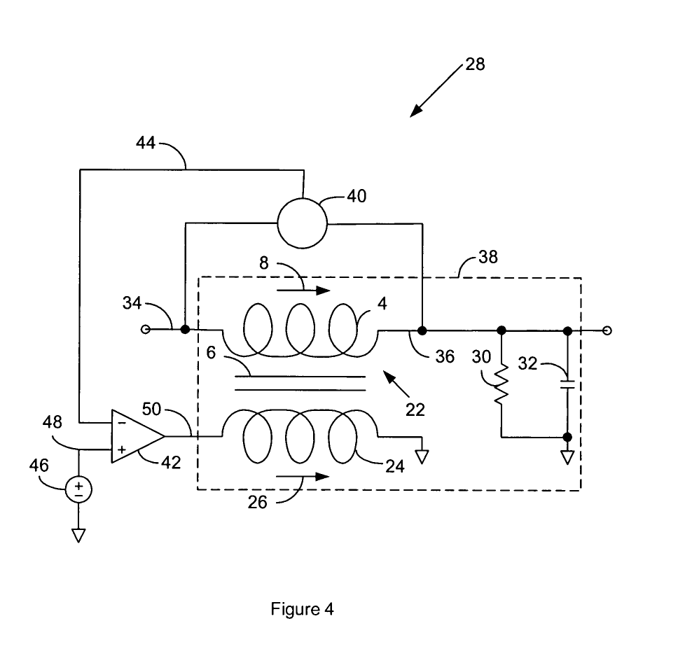

One possible way to make the level of current I₂ track the level of current I₁ so that the net magnetic field H_{NET} remains at or near 0 is with a feedback circuit. FIG. 4 is a simple schematic of one possible embodiment of a feedback circuit 28 to control current through the secondary winding 24 of the inductor 22. Current I₁ from a rectifier circuit (not shown) passes through the primary winding 4 of the inductor 22 to a resistance 30 and capacitance 32 by way of an inductor input line 34 and an inductor output line 36. The inductor 22, resistance 30 and capacitance 32 serve as a choke-input power supply filter 38.

An electrical potential sensor 40 measures AC back electromotive force (EMF) generated as a result of the pulsating DC current that flows through the primary winding 4 of the inductor 22. The sensor 40 preferably is connected such that it measures the maximum AC back EMF across the primary winding 4, such as across the primary winding 4 as shown. An output of the sensor 38 connects to one input of an amplifier 42 by way of a sensor output line 44. A reference electrical potential, such as an electrical potential reference source 46, connects to another input of the amplifier 42 by way of a reference source output line 48. The amplifier 42 has an output connected to the secondary winding 24 by way of an amplifier output line 50.

The reference source 46 has a level that lets the amplifier42 generate a current I₂ level in the secondary winding 24 that minimises the net magnetic field H_{NET} in the magnetic core 6 of the inductor 22 for a given current I₁ level to produce a maximum AC back EMF across the primary winding 4. As the current I₁ level increases or decreases in level, the back EMF across the primary winding 4 also changes, changing the output of the sensor 38 and thereby changing the current I₂ level that the amplifier 42 generates to keep the net magnetic field H_{NET} at a minimum.

Described above is an inductor with a primary winding on a magnetic core that produces a primary magnetic field H₁ with a current I₁ and an electromagnetic field source that generates a secondary magnetic field H₂ in the core that opposes the primary magnetic field H₁ to produce a low net magnetic field H_{NET} in the core to prevent magnetic saturation of the core. The described embodiment is only an illustrative implementation of the invention wherein changes and substitutions of the various parts and arrangements thereof are within the scope of the invention as set forth in the attached claims.

1. A direct current (DC) link inductor with a primary winding for receiving DC on a magnetic core that produces a primary magnetic field H₁ with a current I₁, comprising:
an electromagnetic field source independent of a return circuit path for the current I₁ in the primary winding that generates a secondary magnetic field H₂ in the core that opposes the primary magnetic field H₁ to produce a low net magnetic field H_{NET} in the core to prevent magnetic saturation of the core.

2. The inductor of claim 1, wherein the secondary magnetic field H₂ of the secondary magnetic field source subtracts from the primary magnetic field H₁ in the magnetic core of the inductor to produce a net magnetic field H_{NET}.

3. The inductor of claim 1, wherein the electromagnetic field source comprises a secondary auxiliary winding on the magnetic core with a current I₂.

4. The inductor of claim 3, wherein the secondary magnetic field H₂ has an intensity that cancels the intensity of the primary magnetic field H₁ in the magnetic core.

5. The inductor of claim 4, wherein the level of current I₂ changes with the level of current I₁.

6. The inductor of claim 5, further comprising a feedback circuit that changes the level of current I₂ in response to changes in level of current I₁.

7. The inductor of claim 6, wherein the feedback circuit measures back electromotive force (EMF) developed across the primary winding to generate the level of current I₂ in response to changes in level of current I₁.

8. The inductor of claim 7, wherein the feedback circuit compares the back EMF developed across the primary winding to a reference electrical potential to generate the level of current I₂ in response to changes in level of current I₁.

9. A direct current (DC) link inductor with a primary winding for receiving DC on a magnetic core that produces a primary magnetic field H₁ with a current I₁, comprising:
a secondary auxiliary winding on the magnetic core independent of a return circuit path for the current I₁ in the primary winding with a current I₂ that generates a secondary magnetic field H₂ in the core such that it cancels the primary magnetic field H₁ to produce a low net magnetic field H_{NET} in the core to prevent magnetic saturation of the core.

10. The inductor of claim 9, wherein the secondary magnetic field H₂ has an intensity that cancels the intensity of the primary magnetic field H₁ in the magnetic core.

11. The inductor of claim 10, wherein the level of current I₂ changes with the level of current I₁.

12. The inductor of claim 11, further comprising a feedback circuit that changes the level of current I₂ in response to changes in level of current I₁.

13. The inductor of claim 12, wherein the feedback circuit measures back electromotive force (EMF) developed across the primary winding to generate the level of current I₂ in response to changes in level of current I₁.

14. The inductor of claim 13, wherein the feedback circuit compares the back EMF developed across the primary winding to a reference electrical potential to generate the level of current I₂ in response to changes in level of current I₁.

15. An electrical power source that supplies direct current (DC) to a load and filters the supplied DC, comprising:
a DC link inductor with a primary winding for receiving DC on a magnetic core that produces a primary magnetic field H₁ with a current I₁ and an electromagnetic field source independent of a return circuit path for the current I₁ in the primary winding that generates a secondary magnetic field H₂ in the core that opposes the primary magnetic field H₁ to produce a low net magnetic field H_{NET} in the core to prevent magnetic saturation of the core.

16. The power source of claim 15, wherein the secondary magnetic field H₂ of the electromagnetic field source subtracts from the primary magnetic field H₁ in the magnetic core of the inductor to produce a net magnetic field H_{NET}.

17. The power source of claim 15, wherein the electromagnetic field source comprises a secondary auxiliary winding on the magnetic core with a current I₂.

18. The power source of claim 17, wherein the secondary magnetic field H₂ has an intensity that cancels the intensity of the primary magnetic field H₁ in the magnetic core.

19. The power source of claim 18, wherein the level of current I₂ changes with the level of current I₁.

20. The power source of claim 19, further comprising a feedback circuit that changes the level of current I₂ in response to changes in level of current I₁.

21. The power source of claim 20, wherein the feedback circuit measures back electromotive force (EMF) developed across the primary winding to generate the level of current I₂ in response to changes in level of current I₁.

22. The power source of claim 21, wherein the feedback circuit compares the back EMF developed across the primary winding to a reference electrical potential to generate the level of current I₂ in response to changes in level of current I₁.
